(19) United States
(12) Patent Application Publication
(10) Pub. No.: US 2026/0025570 A1
(43) Pub. Date: Jan. 22, 2026

(54) DISPLAY CONTROL APPARATUS, CONTROL METHOD, AND STORAGE MEDIUM

(71) Applicant: CANON KABUSHIKI KAISHA, Tokyo (JP)

(72) Inventors: TOSHIHIKO SUGIMOTO, Kanagawa (JP); MASATO NAKATA, Kanagawa (JP); TOMOHIRO NISHIYAMA, Tokyo (JP); RYOTARO TAKAHASHI, Tokyo (JP)

(21) Appl. No.: 19/263,933

(22) Filed: Jul. 9, 2025

(30) Foreign Application Priority Data
Jul. 18, 2024 (JP) 2024-114941

(51) Int. Cl. H04N 23/63; G06F 3/16

(52) U.S. Cl. CPC H04N 23/635; G06F 3/167; H04N 23/632

(57) ABSTRACT

A display control apparatus detects a region of an object that is a subject different from a predetermined subject in a captured image including the predetermined subject, and causes a display unit to display an image in which a display manner of the object is controlled with respect to a region of the object in the image. The display control apparatus controls, in response to detection of a trigger for switching a display manner of the object while sequentially acquiring captured images, a display manner of the object to a display manner corresponding to the trigger.

### BACKGROUND

### Field of the Technology

The present disclosure relates to a display control apparatus, a control method, and a storage medium.

### Description of the Related Art

In recent years, a technology of sharing a shot image in real time has become widespread by an online meeting using a web camera or the like, video distribution by an individual, and the like. In such a technology, whereas the quality of communication is improved by presenting and visually sharing an image of a target object to be explained, there is a case where information that should not be originally shared such as privacy and confidential matters are also shared.

Japanese Patent Laid-Open No. 2023-77931 discloses a technology of controlling a focus position of a camera to shoot an object presented in front of the camera and a focus state by a shooter as intended by the shooter. Japanese Patent Laid-Open No. 2011-101161 discloses a technology of protecting privacy of a subject by performing mosaic processing on the subject determined to be unintentionally captured in an image capturing apparatus that records information for protecting privacy of the subject together with an image.

In the technology according to Japanese Patent Laid-Open No. 2023-77931, since the range of the depth of field of the camera is controlled to adjust the focus of the subject to be a target object, the display state of another subject included in the depth of field is also in a focused state similarly to the target object. In the technology according to Japanese Patent Laid-Open No. 2011-101161, the privacy protection level is set based on information determined after shooting, such as the degree of stay within the angle of view and the number of times of going out of frames, and mosaic processing is performed at the time of reproducing a moving image based on the setting. That is, in these patent documents, it is not considered to control display of a region of an intended subject while sharing a shot image.

### SUMMARY

The present disclosure can control, as desired, a display state of a subject included in an image to be shot.

In order to solve the aforementioned issues, one aspect of the present disclosure provides a display control apparatus comprising: one or more processors; and a memory storing instructions which, when the instructions are executed by the one or more processors, cause the display control apparatus to function as: a detection unit configured to detect a region of an object that is a subject different from a predetermined subject in a captured image including the predetermined subject; and a display control unit configured to cause a display unit to display an image in which a display manner of the object is controlled with respect to a region of the object in the image, wherein in response to detection of a trigger for switching a display manner of the object while sequentially acquiring captured images, the display control unit controls a display manner of the object to a display manner corresponding to the trigger.

Another aspect of the present disclosure provides a method of controlling a display control apparatus, the method comprising: detecting a region of an object that is a subject different from a predetermined subject in a captured image including the predetermined subject; and controlling to cause a display unit to display an image in which a display manner of the object is controlled with respect to a region of the object in the image, wherein in the controlling, in response to detection of a trigger for switching a display manner of the object while sequentially acquiring captured images, a display manner of the object is controlled to a display manner corresponding to the trigger.

Still another aspect of the present disclosure provides a non-transitory computer readable storage medium storing an instructions for causing a computer to execute a method of controlling a display control apparatus, the method comprising: detecting a region of an object that is a subject different from a predetermined subject in a captured image including the predetermined subject; and controlling to cause a display unit to display an image in which a display manner of the object is controlled with respect to a region of the object in the image, wherein in the controlling, in response to detection of a trigger for switching a display manner of the object while sequentially acquiring captured images, a display manner of the object is controlled to a display manner corresponding to the trigger.

According to the present disclosure, a display state of a subject included in an image to be shot can be controlled as desired.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a configuration example of each apparatus in a system according to an embodiment of the present disclosure.

FIG. 2 is a block diagram illustrating an example of a functional configuration example implemented by an electric circuit of a display control apparatus in a first embodiment.

FIG. 3 is a flowchart showing a series of operations of display control processing in the first embodiment.

FIGS. 4A to 4D are diagrams describing a control example (from display to hide) of a display manner of an object in the first embodiment.

FIGS. 5A to 5D are diagrams describing another control example (from hide by operation to display) of the display manner of the object in the first embodiment.

FIGS. 6A to 6F are diagrams describing another control example (from hide by action to display) of the display manner of the object in the first embodiment.

FIG. 7 is a diagram describing an example of replacing output audio data in the first embodiment.

FIG. 8 is a block diagram illustrating an example of a functional configuration example implemented by an electric circuit of a display control apparatus in a second embodiment.

FIG. 9 is a flowchart showing a series of operations of display control processing in the second embodiment.

FIG. 10 is a diagram describing a control example of a display manner of an object using shooting environment information in the second embodiment.

FIGS. 11A and 11B are diagrams illustrating another control example of the display manner of the object using the shooting environment information in the second embodiment.

FIGS. 12A to 12E are diagrams describing a control example of a display manner of an object in a third embodiment.

### DESCRIPTION OF THE EMBODIMENTS

### First Embodiment

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Outline of Embodiment

As described above, in recent years, an online meeting using a web camera or the like, video distribution by an individual, and the like are becoming widespread, and in the online meeting or the live video distribution, an image shot using the web camera or the like is shared in real time with participants. Taking advantage of the fact that information can be visually shared by an image, in an online meeting, there is a case where a distributor presents a presentation material such as an object or a document in front of the camera and introduces and explains it to meeting participants by way of an image.

On the other hand, in a case where information is visually shared using an image, there is a case where unnecessary information is also shared. Therefore, in an online meeting, for the purpose of protecting privacy and confidential matters, there is a case where the background is erased or replaced with a dummy image using a function included in online meeting software. In this case, in many cases, an object to present to other meeting participants is not displayed because it is determined as a background contrary to the intention of the user, or conversely, a person or an object desired to hide is captured. That is, it is desirable to appropriately control, in line with the intention of the distributor, the display manner of a subject of which displaying/hiding is desired to switch.

Therefore, in the present embodiment, a trigger for switching a display manner of an object is detected while sequentially acquiring captured images, and in response to detection of the trigger, the display manner of the object is controlled to a display manner corresponding to the trigger. By this, in the present embodiment, a display state of a subject included in an image to be shot can be controlled as desired.

### Configuration Example According to Present Embodiment

Hereinafter, as an example of the display control apparatus, an example of using electronic equipment such as a personal computer that can control the display manner of a subject will be described. However, the present embodiment is applicable also to other equipment that can control the display manner of the subject. These pieces of equipment may include, for example, a digital camera, a smartphone, a game console, a tablet terminal, a wearable terminal, and equipment for a system for broadcasting or video distribution.

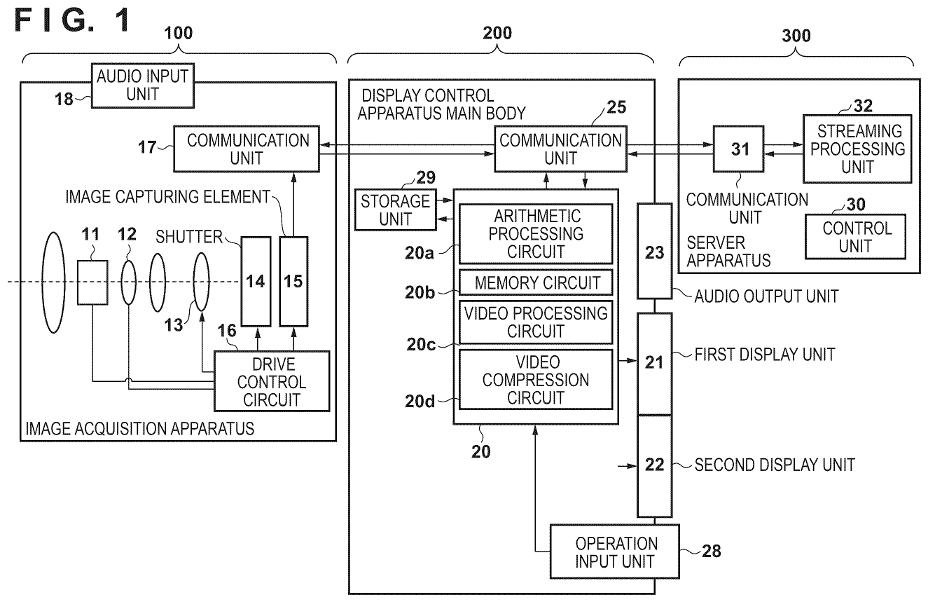

Hereinafter, a configuration of each apparatus in a system including the display control apparatus will be described with reference to FIG. 1. The display control apparatus of the present embodiment includes a camera 100, which is an example of an image acquisition apparatus, and a display control apparatus main body 200. The camera 100 and the display control apparatus main body 200 are connected by an information communication path. The camera 100 is, for example, a web camera or an external camera. Note that although a detachable configuration will be described as an example in the example of the present embodiment, the camera 100 may be configured integrally with the display control apparatus main body 200.

The display control apparatus main body 200 can be connected to a video distribution apparatus 300 on a network by wireless communication or wired communication. The video distribution apparatus 300 is a video distribution server including a video distribution function, for example.

### Configuration of Camera

The camera 100 functions as an image acquisition unit of the display control apparatus. The camera 100 includes, as an image capturing optical system, an aperture 11, a camera shake correction lens group 12, and a focus/zoom lens group 13, and guides an optical image of a subject to an image capturing element 15. A drive control circuit 16 controls an actuator not illustrated or the like based on an arithmetic processing result of an arithmetic processing circuit 20a of the display control apparatus main body transmitted and received via a communication unit 17 on a camera side and a communication unit 25 on a display control apparatus main body side described later. With the control, the aperture of the camera 100, the lens group, and a mechanical shutter 14 of the display control apparatus main body 200 are controlled. The camera 100 includes the image capturing element 15 that generates an image signal by photoelectrically converting a formed optical image, and the mechanical shutter 14 that adjusts an exposure time for exposing the image capturing element 15. A plurality of image signals are sequentially acquired from the image capturing element 15 to form a video signal.

The camera 100 further includes the communication unit 17. The camera 100 controls the aperture and the lens group based on a control signal transmitted and received via the communication unit 17 on the camera side and the communication unit 25 on the display control apparatus main body side. The camera 100 controls the drive timing of the image capturing element 15 and the shutter speed of the mechanical shutter 14 based on the control signal to capture an image with appropriate exposure. Note that the mechanical shutter 14 is unnecessary in a case where the image capturing element 15 includes an electronic shutter function that can adjust the exposure time by controlling a signal accumulation time and a signal reading time. In a case where the mechanical shutter 14 and the electronic shutter function are included and the exposure time is adjusted by the electronic shutter, the mechanical shutter 14 is brought into a fully opened state.

The camera 100 includes an audio input unit 18. The audio input unit 18 includes a microphone and the like, converts input audio into an electric signal, and outputs the electric signal as audio data to the display control apparatus main body 200 via the communication unit 17 on the camera side. Upon receiving the audio data, the display control apparatus main body 200 adds the audio data to the video signal, stores the audio data into a storage unit 29, and records the audio data as electronic data. In the example of the present embodiment, a case where the audio input unit 18 is incorporated on the camera side will be described as an example, but the audio input unit 18 may be incorporated in the display control apparatus main body 200 or may be connected to an external terminal not illustrated as an external apparatus.

### Configuration of Display Control Apparatus

The display control apparatus main body 200 includes a first display unit 21 and a second display unit 22 that can display an image captured by the camera 100, various setting values at the time of shooting by the camera, and the like. The first display unit 21 and the second display unit 22 include, for example, a display device such as a liquid crystal panel or an organic EL. In a case where the camera 100 is attached to or incorporated in the display control apparatus main body 200, the first display unit 21 and the second display unit 22 can be provided on a back surface portion opposite to the camera 100 in the display control apparatus main body 200. In the present embodiment, a case where the first display unit 21 and the second display unit 22 are two display units integrated with the display control apparatus main body 200 will be described as an example, but the first display unit 21 and the second display unit 22 may be configured in a form of dividing a display region in a screen of one display apparatus. Alternatively, the first display unit 21 and the second display unit 22 may be configured as external equipment detachable from the display control apparatus main body 200.

The display control apparatus main body 200 includes an electric circuit 20. The electric circuit 20 includes the arithmetic processing circuit 20a, a memory circuit 20b, a video processing circuit 20c, and a video compression circuit 20d. The arithmetic processing circuit 20a includes one or more processors such as a CPU and an MPU that perform various types of arithmetic processing for controlling the operation of the camera 100 and the display control apparatus main body 200. By executing a control program stored in the storage unit 29, the arithmetic processing circuit 20a controls each unit of the camera 100 and the display control apparatus main body 200. The control program mentioned here includes a program for performing the display control processing of the present embodiment.

The memory circuit 20b is used as a work memory for deploying a program read from the storage unit 29, a buffer memory for temporarily holding an image received from the camera 100, and a video display memory of the first display unit 21 and the second display unit 22.

The video processing circuit 20c converts a video signal based on an image captured by image capturing element 15 into digital data, and performs various types of video processing. The video data output from the video processing circuit 20c is output to the first display unit 21 and the second display unit 22, or compressed into a predetermined data format by the video compression circuit 20d and output to and recorded in the storage unit 29.

The video compression circuit 20d generates a video file by compressing and encoding the video data output from the video processing circuit 20c into a predetermined data format.

The display control apparatus main body 200 includes an operation input unit 28 such as a switch, a button, or a touch panel that receives a user operation. In the present embodiment, the operation input unit 28 includes a shutter switch that instructs shooting preparation or shooting start. By pressing the shutter switch shallow to the first stage, that is, what is called “half-pressing”, operations such as autofocus processing, automatic exposure processing, and automatic white balance processing are started. Furthermore, by pressing the shutter switch deeply from half-pressing to the second stage, that is, what is called “full-pressing”, the mechanical shutter 14 or the electronic shutter function of the image capturing element 15 is activated. Thereafter, a series of shooting processing operations from reading of a signal from the image capturing element 15 to writing of video data into the storage unit 29 are started.

As the operation input unit 28, a switch that allows the user to set an exposure condition for shooting with the camera 100 may be provided. As the operation input unit 28, a switch for switching on/off of input of the audio input unit 18, on/off of output of an audio output unit 23, and display of the first display unit 21 and the second display unit 22 may be provided. A switch that allows the user to turn on or off a video distribution function by the video distribution apparatus 300 described later may be provided. The operation input unit 28 may be configured to receive a user operation as a touch panel integrated with the first display unit 21 and the second display unit 22.

The display control apparatus main body 200 includes the communication unit 25. The communication unit 25 includes an interface circuit for connecting in a communication-enabling manner the display control apparatus main body 200 to external equipment via a network such as the Internet. The display control apparatus main body 200 can transmit and receive data to and from external equipment connected to a wired or wireless network by the communication unit 25. For example, by controlling the communication unit 25, the display control apparatus main body 200 can output the video data processed by the video processing circuit to the video distribution apparatus 300 on the network. The communication unit 25 communicates with the communication unit 17 on the camera side, and transfers an image and audio shot by the camera 100.

The display control apparatus main body 200 includes the storage unit 29 such as a memory card and a hard disk. The storage unit 29 stores a program executed by the arithmetic processing circuit 20a. A video file compressed into a predetermined format by the video compression circuit 20d is recorded in the storage unit 29, and the video file already recorded is read out as necessary. The storage unit 29 may have a form detachable with respect to the display control apparatus main body 200 or may have a form incorporated in the display control apparatus main body 200.

### Configuration of Video Distribution Apparatus

Next, a configuration and a function of the video distribution apparatus 300 of the present embodiment will be described with reference to FIG. 1. The video distribution apparatus 300 includes a control unit 30, a communication unit 31, and a streaming processing unit 32. The control unit 30 includes one or more processors such as a CPU and an MPU that perform various types of arithmetic processing for controlling the operation of the video distribution apparatus 300. By executing a predetermined program, the control unit 30 controls each unit of the video distribution apparatus 300. The predetermined program can implement processing related to video distribution, for example.

The communication unit 31 is connected to the communication unit 25 of the display control apparatus main body 200 via the network, and can transmit and receive data to and from the display control apparatus main body 200 and an external device. The communication unit 31 outputs, to the streaming processing unit 32, video data transmitted from the communication unit 25 of the display control apparatus main body 200.

The streaming processing unit 32 creates a video for distribution based on the video data transmitted from the communication unit 25, and transmits the video to the communication unit 31. The video data subjected to the streaming processing is transmitted to a device on a viewer side not illustrated in FIG. 1 via the communication unit 31.

### Functional Configuration Example Implemented by Electric Circuit

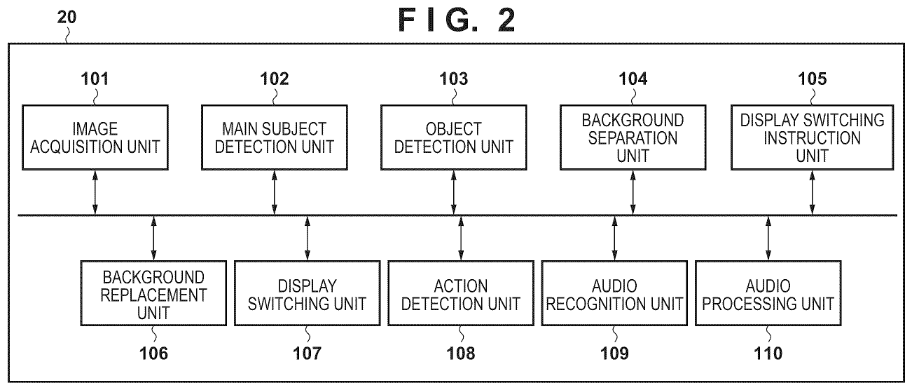

FIG. 2 conceptually illustrates a functional configuration example implemented by the electric circuit 20. The electric circuit 20 includes an image acquisition unit 101, a main subject detection unit 102, an object detection unit 103, a background separation unit 104, a display switching instruction unit 105, a background replacement unit 106, a display switching unit 107, an audio recognition unit 109, and an action detection unit 108. These processing units are stored in the memory circuit 20b as programs, for example, and are implemented by the arithmetic processing circuit 20a executing these programs.

The image acquisition unit 101 sequentially acquires images (i.e., acquires a shot video) from the image capturing element 15 of the camera 100 in real time via the communication unit 17 of the camera 100 and the communication unit 25 of the display control apparatus main body 200.

The main subject detection unit 102 detects a region of a main subject from the images sequentially acquired by the image acquisition unit 101. Here, the main subject is a central subject in a screen, and is, for example, a person subject such as a shooter in a case where the shooter is shooting himself/herself. The main subject detection unit 102 holds in advance feature amounts such as shape information and color information on a person's face and body, and detects in real time a region of the main subject included in the image based on these pieces of held information. Note that the main subject may be a subject that is a target of processing such as AF and frame display.

The object detection unit 103 detects, from sequentially acquired images, a region of an object that is a subject different from the main subject. The object detection unit 103 holds in advance feature amounts such as the shape, color, and information on the subject, and detects a region of the object included in the image based on these pieces of information. The object of the present embodiment may be an object having a shape and a color that can be detected from a shot video, and a specific form is not limited to the present embodiment. In a case where a plurality of objects exist in the shot image, regions of the plurality of objects may be detected. Note that the detection of the regions of the main subject and the object may be performed by one or more machine learning models in which feature amounts such as the shape, color, and information on the subject such as a person and an object are trained in advance.

The background separation unit 104 recognizes and separates, as a background region, an image region other than the main subject detected by the main subject detection unit 102 and the object detected by the object detection unit 103. There is a case where the background region includes a subject having a small size on a screen that has not been detected as a main subject or an object.

The display switching instruction unit 105 acquires display switching trigger information, which is information on a display switching instruction from the user (instruction information for controlling the display manner of the main subject or the object), and gives a control instruction of display switching to the display switching unit 107. The display switching trigger information may be operation information or the like of the button or the touch panel from the operation input unit 28, or may be speech audio information or the like from the user described later.

The background replacement unit 106 replaces the background region of an image separated by the background separation unit 104 with an image with the original background image blurred or with another image.

The display switching unit 107 controls the display manner of the object detected by the object detection unit 103 based on the instruction from the display switching instruction unit 105 (e.g., performs display switching). The display switching unit 107 can perform hiding processing of replacing the region of the object with an image interpolated from a surrounding background region and displaying as if the object does not exist. The display switching unit 107 can perform processing of displaying an object with a blurred image to such an extent that detailed information on the object cannot be discriminated, for example, so as to change a state in which the object is identifiable to a state in which the object is unidentifiable. In a case of receiving an instruction of redisplay (i.e., bring into a state of displaying) the object that has already been subjected to the hiding processing, the display switching unit 107 can perform processing of displaying the original image of the object. In this manner, the control of the display manner according to the present embodiment may include controlling the display manner of the object from any one to the other of a state in which the object is displayed and a state in which the object is hidden. The control of the display manner according to the present embodiment may include controlling from any one to the other of a manner in which the object is identifiable and a manner in which the object is unidentifiable (including blurring the object).

The action detection unit 108 detects an action that is a specific operation of the main subject or the object from a real-time shot video acquired by the image acquisition unit 101. The action detected here includes an action of a hand or a finger indicating a direction of the object whose display is to be switched in a case where the main subject or the object is a person subject. Alternatively, the action detected includes a specific action (also called a gesture) of an arm or a gesture for switching display of the person himself/herself by the action of the person himself/herself who is the subject.

The audio recognition unit 109 detects and recognizes, from audio data acquired from the audio input unit 18, audio representing the name of an object, audio representing the switching content of the display, specific audio relevant to the shooting environment information suggesting the shooting place or surrounding information, and the like. Note that speech indicating the direction of the object whose display is to be switched may be detected and recognized.

An audio processing unit 110 processes audio data acquired from the audio input unit 18 based on the audio recognized by the audio recognition unit 109. For example, the audio processing unit 110 can change the audio emitted by the object whose display manner is controlled to be hidden to a manner different from the audio emitted in a state where the object is displayed. As an example, the audio processing unit 110 can process audio data corresponding to the audio recognized by the audio recognition unit 109 into silence or perform processing of replacing with other audio.

### Series of Operations Related to Display Control Processing

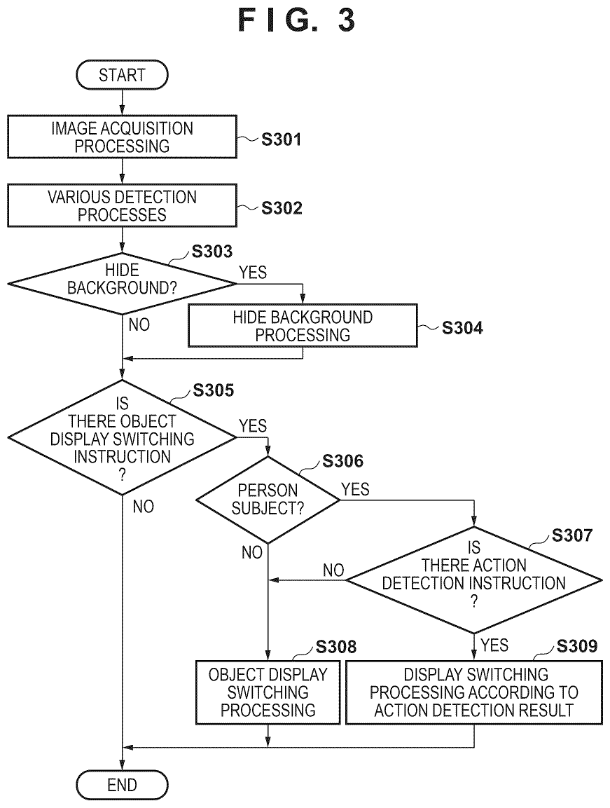

Next, display control processing in a first embodiment will be described with reference to FIG. 3. The flowchart shown in FIG. 3 shows a series of operations of the display control processing in the present embodiment. Note that each process in the display control processing is implemented by the arithmetic processing circuit 20a, which is a part of the electric circuit 20, executing a program stored in the memory circuit 20b. The present display control processing is started by an input operation of the operation input unit 28 for starting shooting and image display operation, for example.

In step S301, the image acquisition unit 101 of the electric circuit 20 acquires a real-time shot video from the image capturing element 15 (sequentially acquires captured images). In step S302, the main subject detection unit 102 and the object detection unit 103 start detection of a region of the main subject and a region of an object that is a subject different from the main subject in the acquired image. A known technology such as deep learning can be used for detection of the region of the object. For example, a machine learning model is trained using a plurality of images in advance so as to detect an object of a detection target, and regions of a main subject or the object in the images are detected using the trained machine learning model. In the present embodiment, regions of a plurality of objects may be detected. Next, the background separation unit 104 separates and recognizes (detects), as a background region, an image region other than the main subject and the object that are detected. Note that step S302 may be executed every time an image constituting a real-time shot video is acquired (e.g., for each frame), or may be executed at a predetermined period.

In step S303, the background replacement unit 106 determines whether there is an instruction to hide the background (background hiding instruction) from the user. In a case of determining that there is a background hiding instruction, the background replacement unit 106 advances the process to step S304, and otherwise, advances the process to step S305. The instruction from the user may be an instruction via an operation member such as a button or a lever included in the operation input unit 28, for example. Alternatively, in a case where the first display unit 21 or the second display unit 22 includes a function of a touch panel, the instruction from the user may be an instruction given with a finger by touching a position or a region where display switching is desired. Furthermore, displaying/hiding of a background region may be set in advance by setting or the like.

In step S304, the background replacement unit 106 executes processing (hiding processing of the background) of hiding the image region recognized as the background in step S302. The hiding processing of the background is processing of generating an image in which a background region is replaced with another image irrelevant to the original background image included in a captured image or an image in which the original background image is blurred.

In step S305, the display switching instruction unit 105 determines whether there is a display switching instruction for the object detected in step S302. In a case of determining that there is a display switching instruction for the object from the user, the display switching instruction unit 105 advances the process to step S306, and otherwise, ends the display control processing. The display switching instruction from the user may be an instruction via an operation member such as a button or a lever of the operation input unit 28, for example. Alternatively, in the case where the first display unit 21 or the second display unit 22 includes a function of a touch panel, the instruction from the user may be an instruction given with a finger by touching a region of a subject where display switching is desired or a position (e.g., an object name) of information indicating a target of display switching.

In step S306, the display switching instruction unit 105 determines whether the display switching target (e.g., an object) is a person subject. For determination of whether the display switching target is a person subject, for example, a known technology using deep learning or the like can be used. In a case of determining that the display switching target is the person subject, the display switching instruction unit 105 advances the process to step S307, and otherwise, advances the process to step S308.

In step S307, the display switching instruction unit 105 determines whether or not to switch the display upon detecting the action of the person subject itself, as the display switching method of the person subject. In a case of determining that there is an action detection instruction from the user, the display switching instruction unit 105 advances the process step S309, and otherwise, advances the process to step S308.

In step S308, the display switching unit 107 executes display switching processing by display processing/hiding processing of an image region of the object whose display switching target is determined not to be the person subject in step S306. The hiding processing may include processing of displaying as if a target object does not exist by replacing the target region with an image interpolated and generated by a known technology from an image around the target region to be hidden. Alternatively, the hiding processing may be processing of making detailed information on the object unidentifiable by replacing the target region with an image in which the object is blurred. Furthermore, the object may be replaced with an image of another alternative object. After executing the switching processing of display, the display switching unit 107 ends a series of operations of the display control processing.

In step S309, in a case where it is determined in step S307 that there is an action detection instruction from the user, the display switching processing is executed upon detecting the action of the display switching target itself that is the person subject. After executing the display switching processing, the display switching unit 107 ends a series of operations of the display control processing. However, the processing of steps S301 to S309 may be repeatedly executed. In this manner, by controlling the display manner of the object separately from the display manner of the main subject, the display switching unit 107 can perform appropriate display control for the object such as hiding the display manner of the object while maintaining the display manner of the main subject.

### Example of Processing of Performing Display Switching by Direct Display Switching Instruction from User

### Processing Example of Switching from Display to Hiding

Both the first display unit 21 and the second display unit 22 of the display control apparatus main body 200 are screens for live view including a touch panel function, and constitute a part of the operation input unit 28 that inputs an instruction from the user by a touch operation on the screen. The first display unit 21 displays an image to be distributed live. The second display unit 22 displays an image that can be visually recognized only by the shooter or the distributor. By visually observing the second display unit 22, the shooter or the distributor can also recognize the information on the object that is hidden. Note that in the example of the present embodiment, an example in which an image to be distributed live and an image that can be visually recognized only by the shooter or the distributor are displayed separately on different display units is illustrated, but two types of images may be displayed side by side in the screen of the first display unit 21.

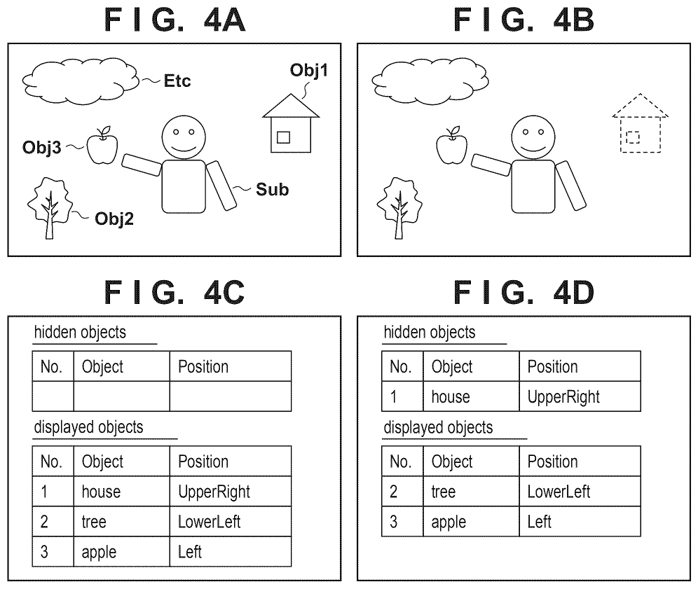

FIG. 4A illustrates an example of an original image (captured image) acquired by the image acquisition unit 101, and is displayed as a live view screen on the first display unit 21. In this example, all subjects are displayed. FIG. 4C is information regarding the display state of FIG. 4A displayed on the live view screen of the second display unit 22 simultaneously with FIG. 4A. The information regarding the display state indicates that, for example, the object detection unit 103 has detected three objects: Obj1 (house), Obj2 (trec), and Obj3 (apple) and all the three detected objects are displayed. The information regarding the display state may indicate that a main subject Sub of a person is detected by the main subject detection unit 102 and the detected main subject is displayed. Furthermore, in the example illustrated in FIG. 4C, an approximate position on the screen of each object is represented by characters. Note that FIG. 4C illustrates that Etc (cloud) is not detected as an object and is recognized as a part of the background region by the background separation unit 104.

An example of processing in which the user switches Obj1 (house) from display to hide from a state where all subjects are displayed in this manner will be described. First, when the user touches the region of Obj1 (house) on the touch panel screen with a finger, the display switching instruction unit 105 acquires display switching trigger information and gives the display switching unit 107 a control instruction of display switching. Upon receiving an instruction to hide Obj1 (house), the display switching unit 107 generates and displays an image in which the region of Obj1 (house) of the first display unit 21 is replaced with an image interpolated and generated from a surrounding background image. Simultaneously, the display switching unit 107 also switches the second display unit 22 to corresponding display. FIG. 4B illustrates a live view screen in which Obj1 (house) is subjected to hiding processing. In the figure, Obj1 (house) is indicated by a broken line for the sake of explanation, but the broken line is not displayed in reality, and is an image similar to the background. FIG. 4D is a display example of the live view screen displayed on the second display unit 22 simultaneously with FIG. 4B. When the shooter or the distributor views the display information on FIG. 4D, it is possible to easily grasp that Obj1 (house) is hidden and the approximate position on the screen when displayed on the first display unit 21. Switching of display of objects other than Obj1 (house) may be performed by the procedure of the display control processing described above. In the above example, the main subject Sub is not illustrated as a display switching target, but the main subject Sub may also be treated as a display switching target similarly to other objects. In this manner, it is possible to switch the display of the plurality of objects included in the captured image.

### Processing Example of Switching Hiding of Object to Display

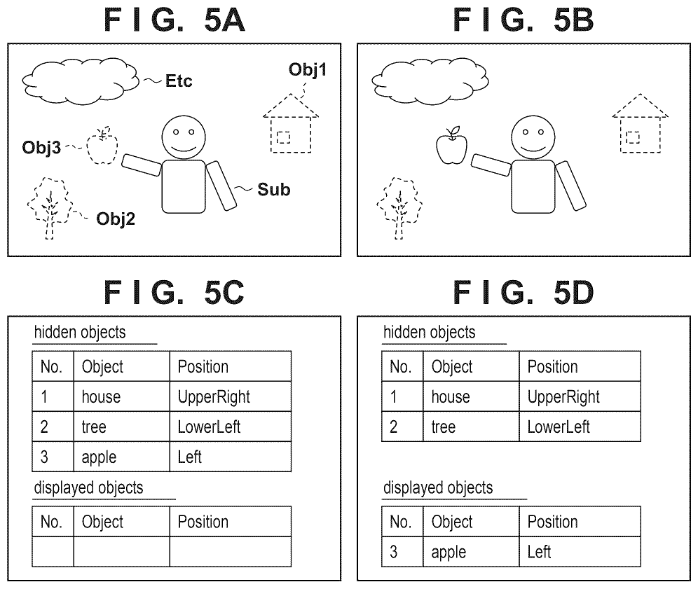

FIG. 5A illustrates that all objects are hidden in a situation where the same object as in FIG. 4A is detected.

Similarly to FIGS. 4A to 4D, FIGS. 5A and 5B are display examples of the live view screen of the first display unit 21, and FIGS. 5C and 5D are display examples of the live view screen of the second display unit 22 that can be visually recognized only by the shooter or the distributor. An example of processing in which the user switches, from hidden to displayed, Obj3 (apple) that is hidden will be described.

For example, the user performs touch operation on a part corresponding to Obj3 (apple) on the live view screen of the second display unit 22 illustrated in FIG. 5C. The display switching instruction unit 105 acquires display switching trigger information from the user, and gives the display switching unit 107 a control instruction of display switching. Upon receiving an instruction to display Obj3 (apple), the display switching unit 107 redisplays the region of Obj3 (apple) of the first display unit 21 as the original image as illustrated in FIG. 5D.

In the example described here, an example in which display is switched by the touch panel has been described, but in a case where the operation input unit 28 includes an operation button, a configuration in which an object whose display is switched by a button operation is selected and on/off of display is switched may be adopted. A configuration in which display switching is performed in response to an instruction by audio from the user may be adopted. Next, a processing example of display switching by audio will be described.

### Example of Performing Display Switching by Audio

A processing example of switching display in accordance with an audio instruction from the user in the situations illustrated in FIGS. 4A to 4D will be described. The audio recognition unit 109 recognizes (detects) specific audio related to display switching from the audio data acquired from the audio input unit 18. For example, first, the user speaks audio “audio switching mode on”, which is a trigger for starting switching processing of display by audio, and the audio recognition unit 109 recognizes (detects) this trigger audio. In this case, the display switching instruction unit 105 starts control of enabling display switching by audio. Next, the user speaks audio including designation (e.g., an object name) of an object to be subjected to display switching and designation (e.g., designation of which to switch to display or hide) of a display manner of the object. The audio recognition unit 109 recognizes (detects) information on the object to be subjected to display switching and information on the display manner (display switching content). In this manner, by detecting an instruction to switch the display manner of an object after an instruction by speech for enabling control of the display manner of the object, it is possible to reduce the risk that the user falsely performs display control based on speech that the user does not intend to switch. The object to be subjected to display switching may be designated by an object name illustrated in FIG. 4C, or may be designated by an object number or other information with which the object can be identified. Regarding designation of the display manner, for example, recognizing the audio “on” means controlling (switching) the object to a displayed state, and recognizing the audio “off” means controlling (switching) the object to a hidden state. For example, when the user speaks audio “house on”, the audio recognition unit 109 gives the display switching unit 107 a control instruction of display switching. Upon receiving an instruction to hide Obj1 (house), the display switching unit 107 replaces and displays the region of Obj1 (house) of the first display unit 21 with an image interpolated and generated from a surrounding background image as illustrated in FIGS. 4B and 4D. The display switching unit 107 updates the display of the second display unit 22 to corresponding information simultaneously with the display control of the first display unit 21. Note that even in a state where display switching by audio is enabled, in order to reduce the influence of false recognition of audio, a switching instruction by a user operation from the operation input unit 28 by a touch panel or the like may be prioritized. In a case where the audio recognition unit 109 recognizes trigger audio “audio switching mode off” that disables display switching by audio, the display switching instruction unit 105 disables the display switching processing by audio.

### Example of Processing of Performing Display Switching by Performing Action Detection

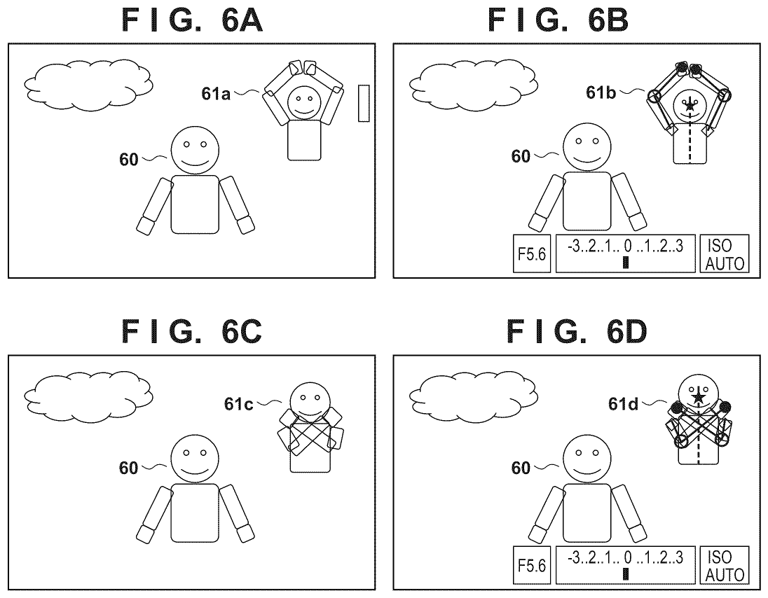

An example of processing of performing display switching by performing action detection will be described with reference to FIGS. 6A to 6F. FIG. 6E illustrates an example of an image in which two person subject of a main subject 60 detected by the main subject detection unit 102 and a person subject 61 detected as an object by the object detection unit 103 are shot. The main subject 60 is a shooter, and shoots an image of himself/herself. In the examples of FIGS. 6A to 6F, the shooter confirms intention of the person subject 61 as to whether or not to display the image of the person subject 61 himself/herself, and performs display switching. First, the shooter gives the person subject 61 an instruction (e.g., orally or by gesture) such as performing a gesture of “circle (◯)” with arms in a case where the person subject 61 may be displayed, and performing a gesture of “cross (x)” in a case where the display cannot be performed. 61a illustrated in FIG. 6A illustrates an example of the gesture in a case where the person subject 61 having received the instruction can be displayed, and 61b illustrates an example of the gesture representing the intention that the display cannot be performed.

The action detection unit 108 performs joint detection of the person subject 61 and detects a gesture regarding whether or not the person subject 61 itself can be displayed. In a case where the gesture of the subject is determined to be the gesture that the person subject 61 can be displayed as in FIG. 6B, the display switching instruction unit 105 continues the display of FIG. 6A. In a case where the gesture of the subject is determined to be the gesture that the person subject 61 cannot be displayed as in FIG. 6D, the display switching instruction unit 105 switches the display to the display on which the hiding processing of the person subject 61 has been performed as in FIG. 6F. Note that in the examples illustrated in FIGS. 6A to 6F, a case where an explicit gesture by the subject is detected has been described as an example, but the detection target is not limited to an explicit gesture by the subject, and may include a predetermined operation (action) of the subject. For example, the display switching instruction unit 105 may perform control (e.g., hide the subject) of switching the display manner of the subject in response to detection of an operation (indicating a non-participation state) in which the subject is speaking sideways or facing downward.

### Example of Processing of Turning Corresponding Part of Output Audio into Dummy Audio in Accordance with Hiding Switching

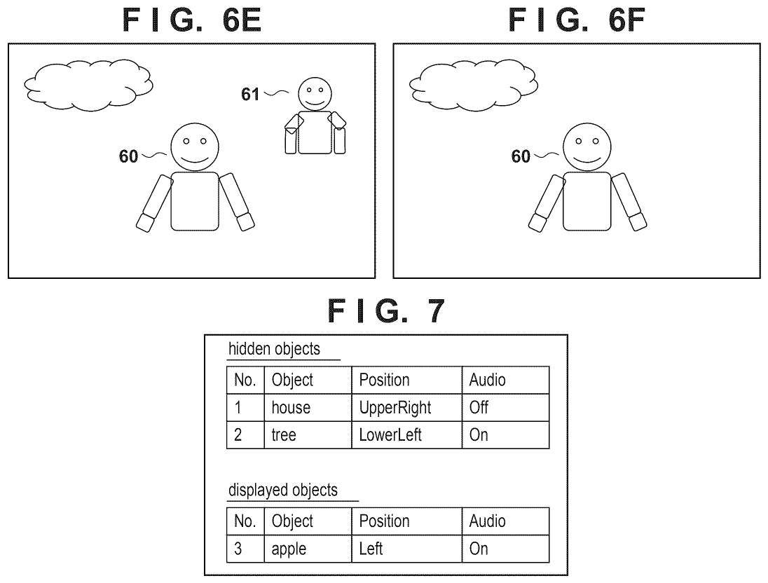

In a case where moving image distribution with audio is performed, processing (hereinafter, referred to as “silencing processing”) of replacing audio corresponding to a hidden object name with dummy audio and outputting the dummy audio may be performed simultaneously in accordance with the hiding switching of the object. Whether or not to execute the silencing processing may be switched by a menu or the like by the user operating the operation input unit 28. In a case where the silencing processing is performed, the audio recognition unit 109 detects in real time the hidden object name from the speech data to be input. Next, the audio processing unit 110 creates and transmits, to the video distribution apparatus 300, audio data in which the corresponding portion where the silencing processing of the input audio data is performed is replaced with dummy audio such as audio of a single frequency. The audio replaced here may be output from the audio output unit 23. Note that in the above example, an example in which the audio corresponding to the hidden object name is replaced with the dummy audio has been described, but the audio emitted by the hidden object may be replaced with the dummy audio in real time. The processing of silencing the object corresponding to the object that is hidden has been described here. However, as illustrated in FIG. 7, the touch panel of the second display unit 22 may switch whether or not to execute the silencing processing for each object independently of the display state of the object.

In this manner, it is possible to perform real-time display according to the intention of the user such as the shooter or the distributor. Even in a case where a plurality of objects are detected, by giving each object an instruction to switch the display manner by the user, the display of the object can be freely and easily switched at the timing intended by the user.

As described above, in the present embodiment, in a captured image including a predetermined subject, the region of an object that is a subject different from the subject is detected, and an image in which the display manner is controlled with respect to the region of the object is displayed on the first display unit 21. At this time, in response to detection of a trigger (for switching the display manner of the object) while captured images are sequentially acquired, the display manner of the object is controlled to a display manner corresponding to the trigger. By doing this, it is possible to control, as desired, a display state of a subject included in an image to be shot.

As described above, the trigger includes an instruction (e.g., user operation, audio, or action) to switch the display manner of the object, and the display manner of the object is controlled to the display manner corresponding to the instruction in response to the detection of the instruction. By doing this, even in a case where a plurality of subjects exist, the user can cause a display state of a desired subject to be displayed as desired.

### Second Embodiment

Hereinafter, a second embodiment will be described. In the first embodiment, a case where, as trigger information for switching display, the user directly switches the display by touch operation or an instruction by audio has been described as an example. On the other hand, as described in the second embodiment, processing of automatically switching display from acquired audio or image information may be performed. In the second embodiment, display switching is automatically performed from shooting environment information. Note that since the configuration of the display control apparatus of the present embodiment is similar to that of the first embodiment, identical components are denoted by identical reference numerals and description thereof will be omitted, and differences will be mainly described.

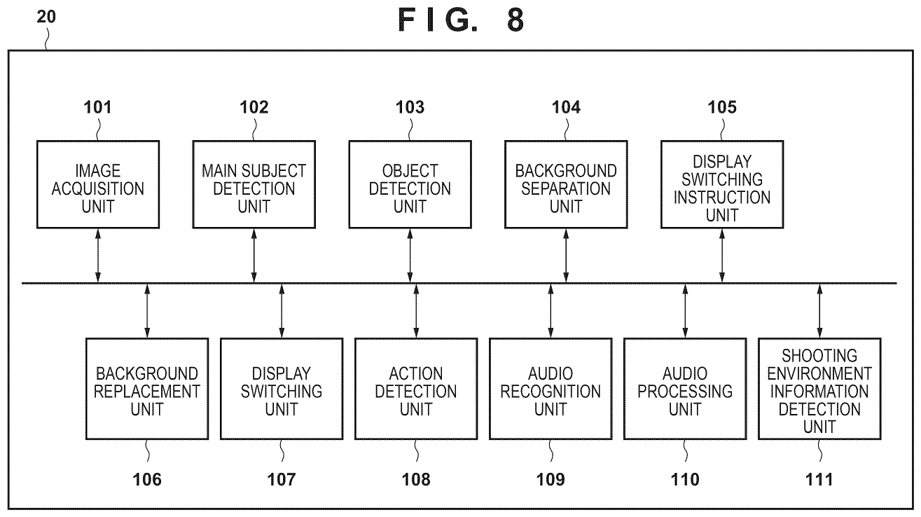

FIG. 8 conceptually illustrates a configuration example of the electric circuit 20 in the second embodiment. The configurations of 101 to 110 in FIG. 8 are the same as those in the first embodiment. In the present embodiment, in addition to the configuration of the first embodiment, the electric circuit 20 includes a shooting environment information detection unit 111.

The shooting environment information detection unit 111 detects shooting environment information described later based on information such as a shot image, audio at the time of shooting, a detected object, and a background region. The shooting environment information can be detected using a known technology such as deep learning, for example. For example, it is possible to use a machine learning model that inputs an image acquired by the image acquisition unit 101, audio acquired by the audio input unit 18, information on an object detected by the object detection unit 103, and a background image extracted by the background separation unit 104 and outputs a type of a shooting scene. It is possible to cause a machine learning model to train in advance using a plurality of pieces of data in which labeled output and input are set, and determine model parameters of the machine learning model.

In a situation where many subjects are detected, in a case where it takes time and effort to individually manually switch the display of individual subjects, in a case where an initial state for display at the time of shooting or starting moving image distribution is performed, or the like, there is a case of desiring to automatically perform control of a display manner substantially matching the user's intention. In such a situation, in the present embodiment, display control processing of automatically controlling the display manner (e.g., turning on and off the display) from the acquired image and audio is performed. By performing the automatic display switching described in the present embodiment, the user only needs to correct the display as necessary based on the result of the automatic display switching, and it is possible to reduce the time and effort of the user's operation.

### Series of Operations Related to Display Control Processing

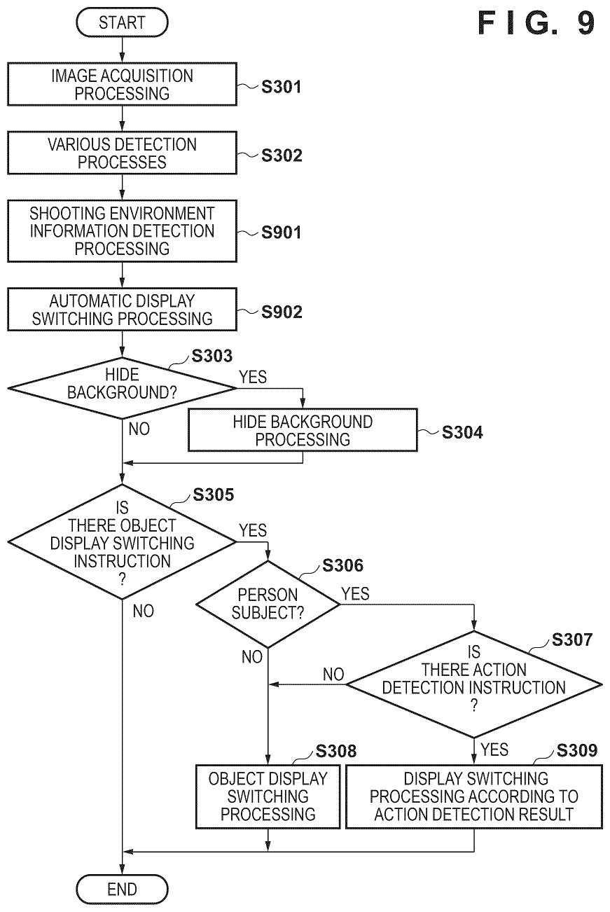

Display control processing in the present embodiment will be described with reference to FIG. 9. Note that each process in the display control processing is implemented by the arithmetic processing circuit 20a, which is a part of the electric circuit 20, executing a program stored in the memory circuit 20b.

First, Similarly to the first embodiment, the image acquisition unit 101 or the like executes processing from step S301 to step S302. Next, in step S901, the shooting environment information detection unit 111 detects shooting environment information based on various types of detection information detected in step S302. The shooting environment information is audio information or image information that suggests a shooting place or a shooting condition or enables the shooting place or the shooting condition to be inferred based on these pieces of information. For example, it is possible to infer that the shooting place is the sea or a beach from audio representing the sound of the wave, and it is possible to infer that the shooting place is outdoors, in particular, a mountain area, a suburb, or the like from an image with green or a mountain area as a background. In a moving image including, behind the main subject, many moving person subjects whose subject size on the screen is smaller than that of the main subject, it can be inferred that the shooter intends to shoot only the main subject and the individual subjects appearing behind should not be identified.

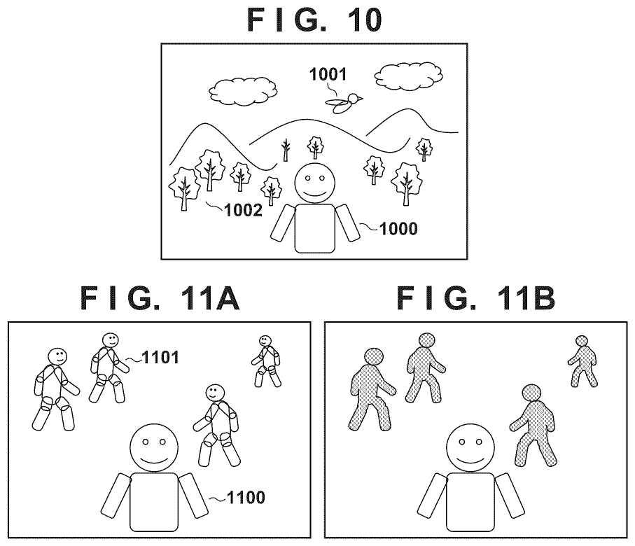

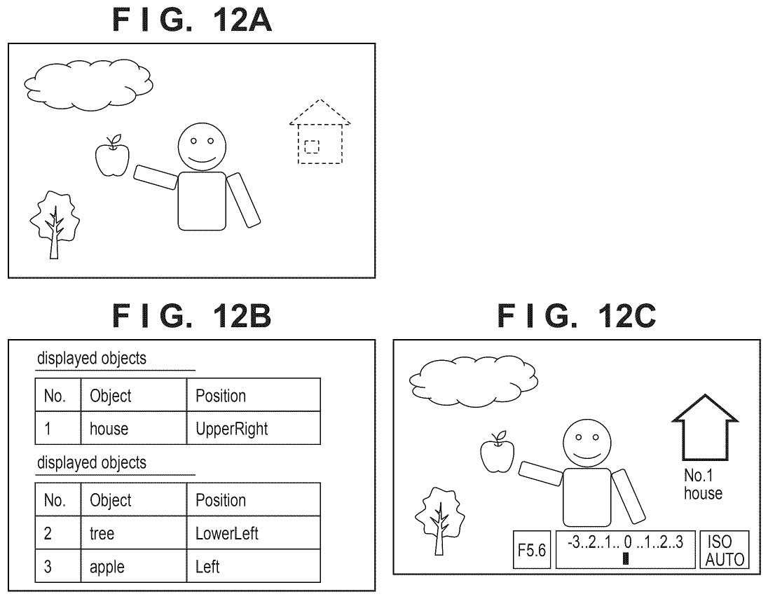

In step S902, the display switching instruction unit 105 performs display switching corresponding to the detected shooting environment information with the shooting environment information detected in step S901 as a trigger. Hereinafter, a specific example will be described with reference to FIGS. 10 and 11A and 11B.

### Automatic Display Switching Corresponding to Shooting Environment Information: Example of Shooting in Mountain

FIG. 10 illustrates an example of a shot distribution image outdoors in a mountain area. A main subject 1000 is shot with the mountains and trees 1002 as the background. The image also includes a bird 1001. In step S302, the main subject detection unit 102 detects the main subject 1000, and the object detection unit 103 detects a plurality of the trees 1002 and the bird 1001 as objects of the target of display switching.

In step S901, the shooting environment information detection unit 111 detects (outputs) a shooting scene of “mountain” by the technology deep learning described above. For example, in the present embodiment, in a case where regions of a predetermined number or more of the same type of objects are detected when a shooting scene of “mountain” is detected, the display switching instruction unit 105 performs processing of excluding these objects from the display switching target and changing the regions to the background region. On the other hand, in a case where the same type of objects of which the number is smaller than a predetermined number NTh are detected, the display switching instruction unit 105 performs display control to distinguish the objects from the background region. Note that in a case where the detected objects correspond to hidden objects designated by the user as a setting in advance, the display switching instruction unit 105 prioritizes the setting and hides the detected objects. At this time, the display switching instruction unit 105 may display the background region. For example, in a case where the number of trees is larger than the predetermined number NTh, in step S902, the display switching instruction unit 105 excludes the trees 1002 from the object and displays the trees as a part of the background region. On the other hand, since the number of the bird 1001 is smaller than the predetermined number NTh, the bird is displayed as an individual object. Through these processing, the original image is displayed as it is in the example illustrated in FIG. 10. In a case where the user switches the background region or the bird 1001 to be hidden, the switching can be controlled by the processing in and after S303 described in the first embodiment.

### Automatic Display Switching Corresponding to Shooting Environment Information: Example of Shooting in Town

FIG. 11A illustrates an example of a shot distribution image in a town where a plurality of people come and go. In this example, in step S302, the main subject detection unit 102 detects the main subject 1100, and the object detection unit 103 detects a plurality of person subjects 1101 as an object. In step S901, the shooting environment information detection unit 111 detects shooting environment information as a shooting scene of “town”. In the present embodiment, in a case where the shooting environment information is detected as “town”, the display switching instruction unit 105 performs processing of hiding the object other than the main subject and the background region. This is processing from the viewpoint of protecting privacy on the assumption that an unspecified large number of people accidentally appear. In step S902, the plurality of person subjects 1101 are hidden. FIG. 11B illustrates an example of an image in which replacement display is performed with an image in which the plurality of person subjects 1101 are blurred to an extent that individuals cannot be identified. In a case where the user switches to a state of displaying the background region and the regions of the plurality of person subjects 1101, the switching can be controlled by the processing in and after S303 described in the first embodiment.

As described above, in the present embodiment, the trigger includes the shooting environment information. In response to the detection of the image shooting environment information, the display manner of the object is controlled to a display manner corresponding to the image shooting environment information. Furthermore, after the image shooting environment information is detected, an instruction to switch the display manner of the object is detected, and the display manner of the object is controlled to the display manner corresponding to the instruction. By doing this, the user only needs to correct the display as necessary based on the result of the automatic display switching, and it is possible to reduce the time and effort of the user's operation. In other words, even in a case where a plurality of subjects exist, it is possible to cause a display state of a desired subject to be displayed as desired.

### Third Embodiment

Next, a third embodiment will be described. As described above, it is desirable to have a configuration including a second display form different from a display form viewed by a distribution viewer so that the user who is the shooter or the distributor can easily grasp which object is displayed or hidden. In the present embodiment, a specific example as the second display form will be described. A suitable display form may be selected according to a shooting environment and a shooting condition. Note that the configuration of the display control apparatus of the present embodiment may be similar to that of the above-described embodiments. Therefore, identical components are denoted by identical reference numerals and description thereof will be omitted, and differences will be mainly described. The display example described below is implemented by the display switching unit 107 in the above-described S308, for example.

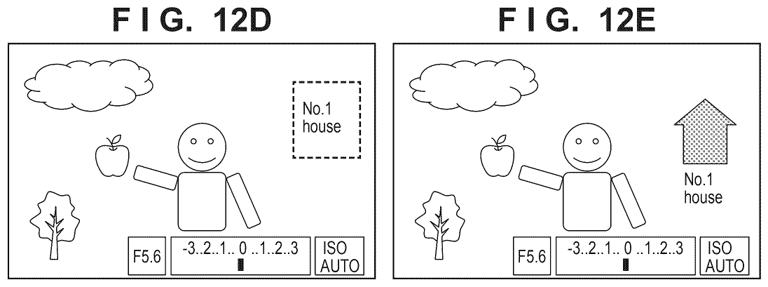

FIG. 12A illustrates a display state similar to the display state illustrated in FIG. 4B in the first embodiment. That is, FIG. 12A illustrates a live view screen in which Obj1 (house) is subjected to hiding processing. In the figure, Obj1 (house) is indicated by a broken line for the sake of explanation, but the broken line is not displayed in reality, and is an image similar to the background. Therefore, the existence of Obj1 (house) cannot be visually observed with the first display unit 21. Similarly to FIG. 4D, FIG. 12B is a display example of the live view screen displayed on the second display unit 22 simultaneously with FIG. 12A. In the example illustrated in FIG. 12B, the current displayed/hidden state of the object is displayed as a “list display with characters”. When the shooter or the distributor views the display information, it is possible to easily grasp that Obj1 (house) is hidden and the approximate position on the screen when displayed on the first display unit 21. This display form is effective, for example, in a case where the shooting place is so bright that it is difficult to understand the luminance and saturation of the live view screen.

In the example illustrated in FIG. 12C, on the live view screen of the second display unit 22, Obj1 (house) that is a hidden object is displayed with “outline emphasis display”. This display form is effective in a case where the size of the object on the screen is relatively large or in a case where the shape of the object is simple. In this display form, the position, size, and shape of the hidden object are obvious at a glance. Since it is possible to intuitively recognize the type of the object whose display is to be switched, the user can perform smooth display switching.

In the example illustrated in FIG. 12D, on the live view screen of the second display unit 22, Obj1 (house) that is a hidden object is displayed with “enclosing border display”. This display form is effective in a case where the size of the object on the screen is relatively small or in a case where the shape of the object is complicated. However, the type of the object cannot be grasped as hidden only by the enclosing border display. Therefore, the display switching unit 107 can make it easier to grasp the object by displaying text indicating the object name and the type inside or around the enclosing border.

In the example illustrated in FIG. 12E, on the live view screen of the second display unit 22, Obj1 (house) that is a hidden object is displayed with “color/luminance/transmittance change display”. This display form is effective for shooting in a room where the color and luminance of the live view screen can be clearly visually recognized or in a relatively dark environment. Similarly to the “outline emphasis display”, this display form also enables the user to intuitively grasp the type of object, and enables smooth display switching.

Note that the above-described display forms are representative display forms, and the display switching unit 107 may perform display in another display form similar to them. The display switching unit 107 may combine one or more of the above-described display forms.

In this manner, in the above-described embodiment, the information indicating the display manner of the object is displayed on the first display unit 21 or the second display unit 22. At this time, the information indicating the display manner of the object includes information indicating that the display manner of the object is hidden by at least one of characters, outline emphasis of the object, the enclosing border, color change, luminance change, and transmittance change. By doing this, the user can intuitively grasp the type, shape, and the like of the object, and can perform smooth display switching.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-114941, filed Jul. 18, 2024 which is hereby incorporated by reference herein in its entirety.

What is claimed is:

1. A display control apparatus comprising:
one or more processors; and
a memory storing instructions which, when the instructions are executed by the one or more processors, cause the display control apparatus to function as:
a detection unit configured to detect a region of an object that is a subject different from a predetermined subject in a captured image including the predetermined subject; and
a display control unit configured to cause a display unit to display an image in which a display manner of the object is controlled with respect to a region of the object in the image,
wherein in response to detection of a trigger for switching a display manner of the object while sequentially acquiring captured images, the display control unit controls a display manner of the object to a display manner corresponding to the trigger.

2. The display control apparatus of claim 1, wherein
the display control unit further controls a display manner of the predetermined subject.

3. The display control apparatus of claim 1, wherein
the display control unit controls a display manner of the object separately from a display manner of the predetermined subject.

4. The display control apparatus of claim 1, wherein
the trigger includes an instruction to switch a display manner of the object.

5. The display control apparatus of claim 1, wherein
the trigger includes shooting environment information, and the shooting environment information includes at least any of a state of an object in an image at a time of shooting and a predetermined sound included in audio at a time of shooting.

6. The display control apparatus of claim 1, wherein
the display control unit controls a display manner of the object related to a first trigger to a display manner corresponding to the first trigger in response to detection of the first trigger including shooting environment information, and
after detecting the first trigger, controls a display manner of the object related to a second trigger including an instruction to switch a display manner of the object to a display manner corresponding to the second trigger in response to detection of the second trigger, and
the shooting environment information includes at least any of a state of an object in an image at a time of shooting and a specific sound included in audio at a time of shooting.

7. The display control apparatus of claim 4, wherein
the instruction includes designation of the object and designation of a display manner of the object.

8. The display control apparatus of claim 4, wherein
an instruction to switch a display manner of the object includes an instruction by a user operation to an operation input unit.

9. The display control apparatus of claim 4, wherein
an instruction to switch a display manner of the object includes an instruction by audio.

10. The display control apparatus of claim 9, wherein
an instruction to switch a display manner of the object includes a second instruction by speech detected after a first instruction by speech for enabling control of a display manner of the object.

11. The display control apparatus of claim 4, wherein
an instruction to switch a display manner of the object includes a predetermined operation by a person who is the object.

12. The display control apparatus of claim 1, further comprising
a changing unit configured to change audio emitted by an object whose display manner is controlled to be hidden to a manner different from audio emitted in a state where the object is displayed.

13. The display control apparatus of claim 1, wherein
the display control unit causes the display unit or a second display unit different from the display unit to display information indicating a display manner of the object.

14. The display control apparatus of claim 13, wherein
information indicating a display manner of the object includes information representing that a display manner of the object is hidden by at least one of a character, outline emphasis of the object, an enclosing border, color change, luminance change, and transmittance change.

15. The display control apparatus of claim 1, wherein
the display control unit controls a display manner of the object from any one to an other of a manner in which the object is identifiable and a manner in which the object is unidentifiable including blurring the object.

16. The display control apparatus of claim 1, wherein
the display control unit controls a display manner of the object from any one to an other of a state in which the object is displayed and a state in which the object is hidden.

17. An image capturing apparatus, comprising
an image capturing unit; and
the display control apparatus according to claim 1.

18. A method of controlling a display control apparatus, the method comprising:
detecting a region of an object that is a subject different from a predetermined subject in a captured image including the predetermined subject; and
controlling to cause a display unit to display an image in which a display manner of the object is controlled with respect to a region of the object in the image,
wherein in the controlling, in response to detection of a trigger for switching a display manner of the object while sequentially acquiring captured images, a display manner of the object is controlled to a display manner corresponding to the trigger.

19. A non-transitory computer readable storage medium storing an instructions for causing a computer to execute a method of controlling a display control apparatus, the method comprising:
detecting a region of an object that is a subject different from a predetermined subject in a captured image including the predetermined subject; and
controlling to cause a display unit to display an image in which a display manner of the object is controlled with respect to a region of the object in the image,
wherein in the controlling, in response to detection of a trigger for switching a display manner of the object while sequentially acquiring captured images, a display manner of the object is controlled to a display manner corresponding to the trigger.
